(19) United States
(12) Patent Application Publication
(10) Pub. No.: US 2014/0075934 A1
(43) Pub. Date: Mar. 20, 2014

(54) LINE CIRCUIT AND METHOD FOR OPERATING A LINE CIRCUIT FOR WASTE-HEAT UTILIZATION OF AN INTERNAL COMBUSTION ENGINE

(71) Applicants: Gregory Rewers, Schwieberdingen (DE); Nadja Eisenmenger, Stuttgart (DE); Achim Brenk, Kaempfelbach (DE); Dieter Seher, Ilsfeld (DE); Hans-Christoph Magel, Reutlingen (DE); Andreas Wengert, Auenwald (DE)

(72) Inventors: Gregory Rewers, Schwieberdingen (DE); Nadja Eisenmenger, Stuttgart (DE); Achim Brenk, Kaempfelbach (DE); Dieter Seher, Ilsfeld (DE); Hans-Christoph Magel, Reutlingen (DE); Andreas Wengert, Auenwald (DE)

(73) Assignee: ROBERT BOSCH GMBH, Stuttgart (DE)

(21) Appl. No.: 14/116,801

(22) PCT Filed: Apr. 27, 2012
(86) PCT No.: PCT/EP2012/057778

§ 371 Date: Nov. 11, 2013

(30) Foreign Application Priority Data
May 10, 2011 (DE) 10 2011 075 557.8

(51) Int. Cl. F02G 5/02

(52) U.S. Cl. CPC F02G 5/02
USPC 60/604; 60/273

(57) ABSTRACT

A line circuit (4) and a method for operating a line circuit (4) for waste-heat utilization of an internal combustion engine (2) are proposed. A working medium circulates in the line circuit (4). The line circuit (4) contains a feed pump (6), at least one heat exchanger (8), an expansion machine (10), a feed-water container (14), in order to store the liquid working medium, and a condenser (12), wherein the feed-water container (14) is connected to the feed pump (6) by way of a line (29). The feed pump (6) has a return-flow line (30), via which liquid working medium can be discharged from the feed pump (6).

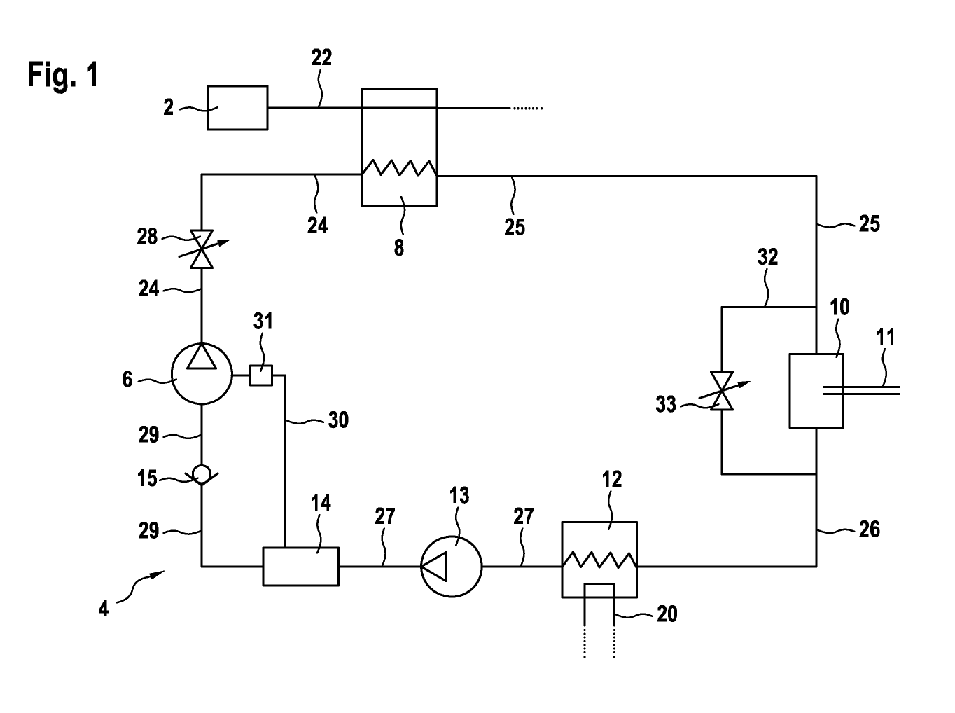

### BACKGROUND OF THE INVENTION

The invention relates to a line circuit and a method for operating a line circuit for waste-heat utilization of an internal combustion engine.

The German patent application DE 102 28 868 B4 discloses a device for producing mechanical work by means of a steam engine. A feed-water container, a feed pump, an evaporator for steam generation, a steam engine and a condenser are disposed in a closed circuit. Feed water from the feed-water container is supplied to the evaporator by means of the feed pump. The feed water is evaporated and supplied to a steam engine. The expanded steam leaving the steam engine is condensed by means of a condenser. The condensed water is fed to the feed-water container. A protective gas space is situated above the feed-water container. When the device is not operating, the protective gas displaces feed water from parts of the closed circuit and thereby protects frost-sensitive parts from damage.

### SUMMARY OF THE INVENTION

The line circuit and the method for operating a line circuit for waste-heat utilization of an internal combustion engine according to the invention have the advantage that the feed pump has a return-flow line, via which liquid working medium can be discharged from the feed pump. An additional hydraulic connection is provided by the return-flow line which makes it possible to remove liquid working medium from the feed pump. Liquid working medium from the interior of the feed pump can be directly discharged via the return-flow line and does not have to be transported away via the lines which lead to the feed pump and away from said feed pump.

After the circulation of the working medium in the line circuit has ended, vaporous working medium coming from the heat exchanger can expand in the line between feed pump and heat exchanger as well as in the feed pump and thereby displaces liquid working medium from the line between feed pump and heat exchanger as well as from the feed pump itself. The liquid working medium which is displaced from the feed pump travels directly into the feed-water container via the return-flow line. By displacing the liquid working medium with vaporous working medium, damage to the feed pump can be prevented in the event a freezing of the line circuit occurs. Damage which occurs as a result of the line circuit freezing can be prevented by means of the vaporous working medium which has expanded in the feed pump and in the connecting lines. Even if the water was not completely removed from the line circuit, the amount of the liquid working medium has in fact been so significantly reduced in said parts of the line circuit that a volume expansion can no longer lead to damage to the components in the event freezing occurs.

A disposal of the return-flow line between feed pump and feed-water container is advantageous because the displaced liquid working medium from the feed pump is transported directly into the feed-water container. The return-flow line is disposed parallel to the line which connects the feed-water container to the feed pump. A return valve which prevents the return flow of working medium can be disposed in the line which connects the feed-water container to the feed pump, thus enabling the return-flow line to be an alternate connection to the feed-water container.

A bypass connection which comprises a bypass valve and is disposed parallel to the expansion machine is advantageous because vaporous working medium is directed by means of the bypass connection directly from the heat exchanger to the condenser when the line circuit is set in operation and helps in the thawing process.

A check valve is advantageously disposed in the line which connects the feed-water container to the feed pump because a flow direction is defined from the feed-water container to the feed pump by means of the check valve. An undesirable backflow of the liquid working medium from the feed pump to the feed-water container is prevented by the check valve during normal operation of the line circuit.

The evacuation of liquid working medium from the feed pump is controlled in a simple manner by a return valve which is disposed in the return-flow line. If the return valve is closed, no liquid working medium can then travel from the feed pump to the feed-water container via the return line. If the feed pump is to be evacuated, the return valve can then be opened and the liquid working medium can thereby be displaced from the feed pump into the feed-water container.

It has been shown to be particularly expedient if the circulation of the working medium is terminated after the internal combustion engine has been shut down because said internal combustion engine cannot give off thermal energy to the line circuit after being shut down and thus a further circulation of the working medium in the line circuit and a further operation of the individual components of the line circuit are not required. Energy consumption can be reduced by terminating the further operation of individual components of the line circuit.

A particular advantage of the invention becomes apparent if the liquid working medium is directed from the feed pump into the feed-water container because said feed-water container is a reservoir within the line circuit by virtue of the fact that larger amounts of the liquid working medium can be stored. Due to this provision, an additional container for storing the liquid working medium is not required.

It is advantageous if the bypass valve of the bypass connection is closed so that the return of the vaporous working medium to the condenser via the bypass connection is blocked. The vaporous working medium, which is subjected to a great deal of pressure in the heat exchanger, has only the possibility of expanding in the direction of the feed pump and in this way particularly effectively displaces the liquid working medium from the feed pump to the feed-water container.

Provision is made for a particularly simple option for controlling the displacement of the liquid working medium out of the feed pump by means of the disposal of the return valve in the return line. If liquid working medium is to be displaced out of the feed pump, this displacement is achieved by opening the return valve. After the liquid working medium has been displaced, the return valve is closed.

### BRIEF DESCRIPTION OF THE DRAWINGS

An exemplary embodiment of the invention is depicted in the drawing and is explained in detail in the following description. A line circuit is schematically depicted in the single FIGURE.

### DETAILED DESCRIPTION

A working medium circulates in the line circuit 4 for waste-heat utilization of an internal combustion engine 2. At least one heat exchanger 8, one expansion machine 10, one condenser, one feed-water container 14 and at least one feed pump 6 are disposed in the line circuit 4.

The internal combustion engine 2 can particularly be designed as an air compressing, self-igniting internal combustion engine 2 or as a mixture-compressing, spark ignition internal combustion engine 2. The line circuit 4 and the associated method for operating the line circuit 4 for waste-heat utilization is particularly suited to applications in motor vehicles. The method for operating the line circuit 4 of the invention is however also suitable for other applications.

The internal combustion engine 2 burns fuel in order to produce mechanical energy. The exhaust gases resulting therefrom are discharged via an exhaust gas system in which an exhaust gas catalyst can be disposed. A line section 22 of the exhaust gas system is fed through the heat exchanger 8. Thermal energy from the exhaust gases or the exhaust gas recirculation is given off to the working medium in the line circuit 4 via the line section 22 in the heat exchanger; thus enabling the working medium to evaporate and superheat in the heat exchanger 8.

The heat exchanger 8 of the line circuit is connected via a line 25 to the expansion machine 10. The expansion machine 10 can be embodied as a turbine or piston machine. The evaporated working medium flows via the line 25 from the heat exchanger 8 to the expansion machine 10 and drives the same. The expansion machine 10 can comprise a drive shaft 11 via which said expansion machine 10 is connected to a load. In so doing, mechanical energy can, for example, be transferred to a drive train or serve to drive an electric generator of a pump or something similar.

After passing through the expansion machine 10, the working medium is fed via a line 26 to the condenser 12. The working medium expanded via the expansion machine 10 is cooled in the condenser 12. The condenser 12 can be connected to a cooling circuit 20. Said cooling circuit 20 can, for example, relate to a cooling circuit of the internal combustion engine 2.

The working medium liquefied in the condenser 12 is transported via a further line 27 to the feed-water container 14. In addition to the feed pump 6, a condenser pump 13 can be situated in the line circuit 4 in the section of the line 27. The condenser pump 13 transports the liquefied working medium from the condenser 12 to the feed-water container 14. The feed-water container 14 serves as a reservoir for the liquid working medium in the line circuit 4.

The fluid working medium from the feed-water container 14 is transported via the line 29 from the feed pump 6 into the line 24. A check valve 15 can be situated in the line 29 in order to define a direction of flow from the feed-water container 14 to the feed pump 6. The check valve 15 prevents the liquid medium from flowing out of the feed pump 6 back to the feed-water container 14.

A first valve 28 can be situated in the line 24, said first valve 28 serving in the form of a pressure regulating valve for regulating the pressure of the working medium in the feed to the heat exchanger 8. The evaporation temperature of the working medium can be regulated with the aid of the above-mentioned pressure in the feed to the heat exchanger 8.

The line 24 leads directly to the heat exchanger 8 in which the working medium is evaporated or if need be superheated. The evaporated working medium arrives once again via the line 25 at the expansion machine 10. The working medium passes again through the line circuit 4. A direction of passage of the working medium through the line circuit 4 is determined by the at least one feed pump 6 and the expansion machine 10. Via the heat exchanger 8, thermal energy, which is released in the form of mechanical or electrical energy, can thus be continually extracted from the exhaust gases and the components of the exhaust gas recirculation of the internal combustion engine 2.

Provision can be made in the line circuit 4 for a bypass connection 32 which is disposed parallel to the expansion machine 10. By means of the bypass connection 32, vaporous working medium can flow by the expansion machine 10. The vaporous working medium leaves the heat exchanger 8 and arrives via the line 25 at the bypass connection 32, from which it travels via the line 26 to the condenser 12.

A bypass valve 33 can be disposed in the bypass connection 32, the former being closed during normal operation of the line circuit 4. If the vaporous working medium is be guided past the expansion machine 10, e.g. when the expansion machine 10 is shutdown, the bypass valve 33 is then opened, which then makes it possible for the vaporous working medium to flow past the expansion machine 10.

The line circuit 4 has a return-flow line 30. The return-flow line 30 is disposed in parallel to the line 29 which connects the feed-water container 14 to the feed pump 6. The return-flow line 30 is a direct connection between the feed pump 6 and the feed-water container 14. On account of the return-flow line 30, it is possible for liquid working medium to flow from the feed pump 6 to the feed-water container 14. The return-flow line 30 can thereby be connected to a plurality or all internal volumes of the feed pump 6 in which a liquid volume can be situated. A disposal of the connection between feed pump 6 and return-flow line 30 is advantageous at a low point within the feed pump 6 in order to support the evacuation process by means of the force of gravity.

A return valve 31 is disposed in the return-flow line 30, which return valve 31 can block the connection between feed pump 6 and feed-water container 14. Under normal operating conditions, the return valve 31 is closed in order to block the working medium in the direction of the feed-water container 14.

Water or another liquid which meets the thermodynamic requirements can be used as the working medium. The working medium undergoes thermodynamic changes in state, which ideally correspond to a Rankine cycle process, when passing through the line circuit 4. In the liquid phase, the working medium is compressed by the feed pump 6 to the pressure level for evaporation. The thermal energy of the exhaust gas is subsequently transmitted to the working medium via the heat exchanger 8. In the process, said working medium is isobarically evaporated and subsequently superheated. The vaporous working medium is then adiabatically expanded. Mechanical or electrical energy is thereby obtained. The vaporous working medium is now cooled in the condenser 12 and delivered again to the heat exchanger 8 via the feed pump 6.

Due to the use of water or another liquid, which can freeze at low temperature, the line circuit 4 or parts of the line circuit 4 comprising particularly sensitive components must be made frost-proof. Due to the freezing of the working medium, said working medium undergoes a change in state via which the same can solidify and expand. Components of the line circuit 4 can be destroyed or damaged during the course of this process.

The inventive method for operating a line circuit 4 for waste-heat utilization of an internal combustion engine 2 represents a possibility for making components of the line circuit 4 frost-proof by means of complete or partial evacuation of the liquid working medium. To this end, liquid working medium in the feed pump 6 is displaced by vaporous working medium, which comes from the heat exchanger 8, after the circulation of the working medium has ended.

After a shutdown of the internal combustion engine 2, the expansion machine 10 and the at least one pump 6, 13 are switched off. The working medium no longer circulates through the line circuit 4.

After the circulation of the working medium has ended, the vaporous working medium, which was produced in the heat exchanger 8, can no longer enter into the condenser 12 via the expansion machine 10. The vaporous working medium from the heat exchanger 8, which is under pressure, expands and displaces the liquid working medium out of the heat exchanger 8 and the connecting lines 24, 25. Because the vaporous working medium cannot expand in the direction of the condenser 12 on account of the expansion machine 10 being shut down, said vaporous working medium flows into the line 24 and the subsequently connected feed pump 6. The liquid working medium, which is situated in the line 24 and in the feed pump 6, is displaced by the expanding vaporous working medium into the return line 30 and from there into the feed-water container 12. In order to facilitate a flow of the liquid working medium from the feed pump 6 to the feed-water container 14, the return valve 31 in the return line 30 is opened.

If a first valve 28 is situated in the line 24, said first valve 28 is then completely open for the method according to the invention; thus enabling the vaporous working medium to expand in the line 24 up to the feed pump 6.

After portions of the liquid working medium have been displaced from the line 24 or the feed pump 6 by the vaporous working medium, the pressure drops on the liquid working medium remaining in the heat exchanger 8. As a result of the reduction of pressure in the heat exchanger 8, the evaporation temperature drops, so that the liquid working medium still remaining in the heat exchanger 8 is evaporated due to the thermal energy stored in the heat exchanger 8. This working medium, which is subsequently evaporated, also expands in the lines 24, 25; thus enabling the evacuation of the heat exchanger 9 to continue.

After the partial evacuation of the line circuit 4, the return valve 30 is closed. A large amount of vaporous working medium having a high temperature is situated in the line 28 and in the feed pump 6. When the line circuit 4 is cooled down further, the pressure of the working medium drops further; and therefore only portions of the vaporous working medium are again liquefied. If freezing occurs, the small quantities of the liquid working medium cannot cause damage to the components of the line circuit 4, as, for example, the heat exchanger 8 and the feed pump 6.

If a bypass connection 32 is located in the line circuit 4, which is disposed parallel to the expansion machine 10, the bypass valve 33 must then be closed for the method for operating the line circuit 4. This means that the bypass valve 33 remains closed or is closed after the end of the circulation of the working medium; and therefore the vaporous working medium from the heat exchanger 8 has no chance of arriving at the condenser 12 via the bypass connection 32 leading past the expansion machine 10.

1. A line circuit (4) for waste-heat utilization of an internal combustion engine (2), a liquid working medium circulating in the line circuit (4) which contains a feed pump (6), at least one heat exchanger (8), an expansion machine (10), a feed-water container (14), in order to store the liquid working medium, and a condenser (12), wherein the feed-water container (14) is connected to the feed pump (6) by way of a line (29), characterized in that the feed pump (6) has a return-flow line (30), via which liquid working medium can be discharged from the feed pump (6).

2. The line circuit (4) according to claim 1, characterized in that the return-flow line (30) is disposed between the feed pump (6) and the feed-water container (14) parallel to the line (29).

3. The line circuit (4) according to claim 1, characterized in that a bypass connection (32) comprising a bypass valve (33) is disposed parallel to the expansion machine (10).

4. The line circuit (4) according to claim 1, characterized in that a check valve (15) is disposed in the line (29) in order to define a direction of flow from the feed-water container (14) to the feed pump (6).

5. The line circuit (4) according to claim 1, characterized in that a return valve (31) is disposed in the return-flow line (30), said return valve (31) blocking the working medium in a direction of the feed-water container (14).

6. A method for operating a line circuit (4) for waste-heat utilization of an internal combustion engine (2) according to claim 1, wherein components of the line circuit (4) are made frost-proof by partially evacuating the liquid working medium, characterized in that liquid working medium in the feed pump (6) is displaced by vaporous working medium, which comes from the heat exchanger (8), after circulation of said working medium has ended.

7. The method according to claim 6, characterized in that an end of the circulation of the working medium occurs after the internal combustion engine (2) has been shut down.

8. The method according to claim 6, characterized in that the liquid working medium is directed from the feed pump (6) into the feed-water container (14).

9. A method for operating a line circuit (4) for waste-heat utilization of an internal combustion engine (2) according to claim 3, wherein components of the line circuit (4) are made frost-proof by partially evacuating the liquid working medium, characterized in that liquid working medium in the feed pump (6) is displaced by vaporous working medium, which comes from the heat exchanger (8), after circulation of said working medium has ended, and characterized in that the bypass valve (33) of the bypass connection (33) is closed in order to displace the liquid working medium from the feed pump (6); and therefore return of the vaporous working medium via the condenser (12) is blocked and return of the vaporous working medium is only enabled via a return line (30).

10. A method for operating a line circuit (4) for waste-heat utilization of an internal combustion engine (2) according to claim 5, wherein components of the line circuit (4) are made frost-proof by partially evacuating the liquid working medium, characterized in that liquid working medium in the feed pump (6) is displaced by vaporous working medium, which comes from the heat exchanger (8), after circulation of said working medium has ended, and characterized in that the return valve (31) is opened in order to displace the liquid working medium from the feed pump (6).

11. The method according to claim 10, characterized in that the return valve (31) is closed after the liquid working medium has been displaced from the feed pump (6).
